(19) United States
(12) Patent Application Publication
(10) Pub. No.: US 2007/0071963 A1
(43) Pub. Date: Mar. 29, 2007

(54) Design system

(75) Inventor: William J. Barz, St. Clair, MI (US)

Correspondence Address: DOBRUSIN & THENNISCH PC, 29 W LAWRENCE ST, SUITE 210, PONTIAC, MI, 48342, US

(73) Assignee: L&L Products, Inc., Romeo, MI (US)

(21) Appl. No.: 11/531,067

(22) Filed: Sep. 12, 2006

Related U.S. Application Data
(60) Provisional application No. 60/720,867, filed on Sep. 27, 2005.
(60) Provisional application No. 60/740,766, filed on Nov. 30, 2005.

(51) Int. Cl. B32B 27/00

(52) U.S. Cl. 428/319.7

(57) ABSTRACT

A design system includes multiple masses of material that are arranged according to a pattern and melted to form a design. In one embodiment, the design system for a mosaic using a predetermined and computer generated pattern.

### CLAIM OF PRIORITY

This application claims the benefit of the filing date of U.S. Provisional Application Nos. 60/720,867 filed Sep. 27, 2005 and 60/740,766 filed Nov. 30, 2005.

### FIELD OF THE INVENTION

The present invention is predicated upon the provision of a system and method for creating designs through the melting of masses onto a substrate in a free form manner, pre-patterned manner or a combination thereof.

### BACKGROUND OF THE INVENTION

In the field of creative, leisure and entertainment activities (e.g., arts, crafts, games and hobbies), there is a continuing need for novel systems or methods that feed the continuous human appetite entertainment and/or novel system that appeal to one or more human interests. For example, it is often desirable for a system to be entertaining while additionally appealing to an individual's desire for creative design. As another example, it can be desirable for a system to provide entertainment while additionally educating or providing mental stimulation. As such, the present invention provides a system can appeal to an individual's desire for plural different human interests.

### SUMMARY OF THE INVENTION

Accordingly, a design system is provided, the system including a plurality of masses of meltable material wherein the masses can be provided in multiple different colors or hues. The system also typically includes a map having markings that correlate to a design wherein the map can be computer generated. Within the system, the masses can be melted to cooperatively form a representation of the design and, according to one embodiment, the representation is preferably a mosaic. The system can also include a substrate that can provide multiple openings suitable for receipt of the mass of meltable material. It is also possible for the multiple openings to align with markings of the map for indicating where the masses of meltable material are to be located. The masses of meltable material can be configured to melt in a conventional baking oven.

### BRIEF DESCRIPTION OF THE DRAWINGS

FIG. 1 illustrates a generic exploded perspective view of one embodiment of the design system according to the teachings of the present invention.

FIG. 2 illustrates a perspective view of one assembled embodiment of the design system according to the teachings of the present invention.

FIG. 3 is a top view of one embodiment of a map according to the teachings of the present invention.

FIG. 4 is a perspective view of one embodiment of a substrate according to the teachings of the present invention.

FIGS. 5A & 5B illustrates examples of designs formed according to the teachings of the present invention.

FIG. 6 illustrates another example of a design formed according to the teaching of the present invention.

### DETAILED DESCRIPTION

In general, the present invention is predicated upon a method and system for the formation of designs, particularly mosaic designs, based upon spontaneous creations, design directions, or a combination thereof. The system and method includes providing a substrate (such as a tray or otherwise) having a plurality of openings formed therewith for creating a grid, wherein the plurality of openings are configured for receiving meltable masses (such as pellets). The user places the masses in the grid according to directions (such as a map or otherwise) or in a free form manner, wherein the masses can include different colors, hues, or otherwise. The masses are then activated to cause softening and/or melting of the same to form a mosaic design. Optionally, the design map or directions for placement of the masses may be based upon the likeness of a user, a desired picture, or otherwise by converting the same into a design map corresponding to the openings of the substrate.

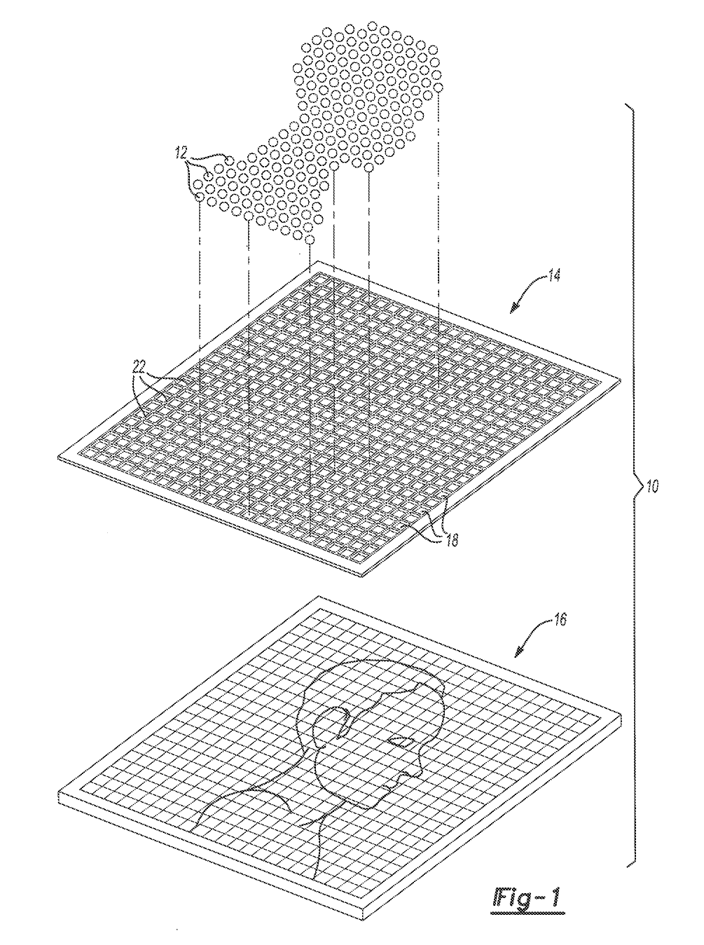

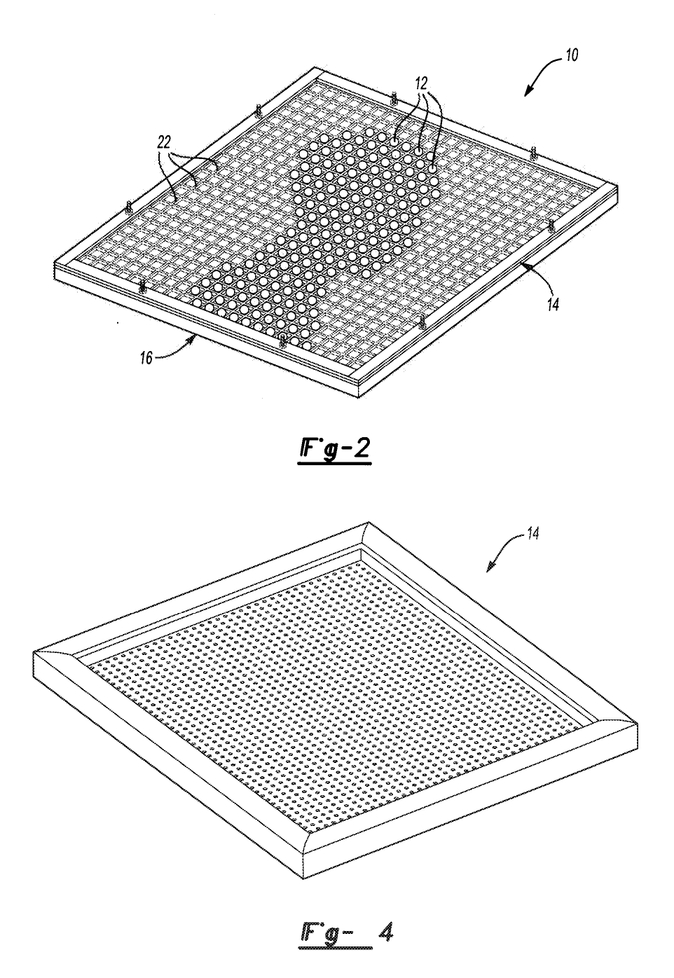

Referring to FIG. 1, one configuration of the system 10 of the present invention is shown. In general, the system includes a plurality of meltable masses 12, shown here in a pellet configuration. The pellets are adapted to be placed over and/or upon a substrate 14 which is adapted to provide support of the masses, preferably both prior to and during melting of the masses. Optionally, the system includes a map 16 which may be attached to or incorporated with the substrate for providing indication of placement of the masses relative to the substrate.

Pellets

The system typically includes a plurality of masses adapted for forming a design according to the teachings of the present invention. The masses are adapted to flow upon application of an energy source. For example, the masses can be exposed to heat such that the masses partially or substantially soften, liquidize, flow, or a combination thereof. Upon cooling, the melted masses re-solidify. Upon re-solidification, the plurality of masses may remain separate or may substantially join together, but typically create a mosaic or other design.

The plurality of masses may be configured to provide different appearance, with respect to each other, particularly upon melting and/or re-solidification of the same. Preferably, the plurality of masses provide multiple (e.g., 2, 3, 4, 5 or more) different colors (e.g., red, orange, yellow, green, blue, indigo, violet, combinations thereof, or otherwise), hues (e.g., black, dark grey, lighter grey and white, combinations thereof, or otherwise), tints, shades, or otherwise. It is also contemplated that pellets of a single hue (e.g., black pellets) may be used to form a design such as a profile of an object.

Optionally, the plurality of masses may also be configured to include effects to vary the appearance of the design. For example, the masses may include gloss, glitter, tints, sparkles or otherwise. Also, it is contemplated that the masses may include fragrance which may or may not correspond to the appearance or theme of the mosaic design. In view of the forgoing, it is contemplated that the system includes a plurality of masses which provide multiple colors or hues or one single color or hue.

The plurality of masses may be configured in different shapes and sizes. However, in one preferred configuration, the masses are shaped as pellets and are substantially consistent in size and shape. The pellets may comprise various three dimensional shapes including cubicle, cylindrical, spherical, ellipsoidal, conical, pyramid, tetrahedron, prism, asymetrical shapes, non-geometric shapes or otherwise. The pellets may include similar or dissimilar three dimensional shapes. However, in one preferred embodiment, the pellets comprise a plurality of conical portions.

While the plurality of masses are hereforth referred to as pellets, it should be appreciated that other configurations of masses are available. Furthermore, the features described with the pellets may be included with other forms of masses and should not be limited thereto.

The size of the pellets is preferably suitable for placement onto or over the substrate. More preferably, the pellets are sized to fit one pellet or mass per opening formed with or included with the substrate, although more than one pellet may also be placed in each opening. Accordingly, it is contemplated that the pellets have a largest diameter or dimension of less than about 2 cm, or less than about 1 cm, or less than about 0.5 cm, or even less than about 0.25 cm. It should be appreciated that the size and shape between the different pellets may vary. Moreover, it should be recognized that any number of pellets or masses may be used to create a design; however, it is preferable for several (e.g., at least 4, 10, 20, 30 or more) pellets or masses to be used for one design.

The pellets may be formed using suitable techniques for mass production of shaped components. Such techniques include blow molding, rotation molding, injection molding, compression molding, casting, or otherwise. In one highly preferred configuration, the pellets are formed through an extrusion process. The extrusion process may include mixing the ingredients forming the pellets. The mixed ingredients are extruded through an extruder and cut using a suitable cutting device. The pellets may also be formed through a batch mixer and die configuration wherein the material forming the pellets travel through a die and are cut into pellets using a rotary cutter.

The pellets are typically formed of polymeric materials such as plastics, thermoplastics, thermosets, elastomers or the like. Exemplary polymeric materials include, without limitation, polyamides, polyethylenes, acrylates, acetates, epoxy resins, propylenes, PVCs, combinations thereof or the like. However, in one preferred configuration the pellets are formed of a material that includes an ethyl butyl acrylate (EBA), an ethyl vinyl acetate (EVA) or both.

Preferably, the pellets are configured to melt, solidify, or both, in a temperature range of a home cooking oven. Accordingly, the melting temperature of the pellets may be between the range of about 50-350° C., or between the range of about 285-300° C., or between the range of about 265-325° C., or even between the range of about 250-350° C. Higher or lower temperatures may also be used unless otherwise specifically stated.

Optionally the pellets may include a curing agent for facilitating in the curing of the pellet upon an application of heat or otherwise. The curing agent may improve reaction of the pellets during application of heat by facilitating in melting or solidification of the pellet. Similarly, the pellets may also include a blowing agent for forming and/or increasing the volume of the pellets during activation (e.g., application of heat or otherwise).

When used, various blowing agents may be employed with the present invention and the choice of blowing agents can depend upon the suitability of the blowing agent for use with one or both of the polymeric material. Examples of blowing agents include chemicals with one or more nitrogen containing groups such as amides, amines and the like. According to one preferred embodiment, it is contemplated that the resin component of the present invention is formulated wish a physical blowing agent and, more particularly, a blowing agent having a thermoplastic shell with a solvent core. An example of a preferred blowing agent, which according to the present invention is formulated with the resin component, is sold under the trade name EXPANCEL 820-DU and is commercially available from Expancel Inc., 2240 Northmont Parkway, Duluth, Ga., 30096 or Expancel, Box 13000, S-850 13 Sundsvall, Sweden. Preferably, the solvent core of the blowing agent of the present invention is a liquid, but such is not required.

Substrate

Referring to FIGS. 1, 4 and 6, the system may also include a substrate adapted for supporting and/or receiving the pellets. The substrate may include one or more openings 18 (e.g., cavities, recesses, through-holes or the like) for placement of the pellets. Also, the substrate may include one or more substantially flat portion 20 for placement of one or more pellets. Furthermore, the substrate may include a combination of openings and flat portions for placement of the pellets.

The openings of the substrate may be defined in the one or more flat portions of the substrate or may be defined by a component of the substrate attached to the portions. In one preferred embodiment, the openings are fixedly positioned relative to the substrate such that the openings do not move along the surface of the substrate.

In one configuration, the openings are formed with the substrate and defined by a plurality of members 22, which may be integrally formed of a single material or may comprise multiple members 22 contacting or spaced from each other. Preferably, the plurality of members forms a grid for the placement of the pellets. In one embodiment, it is contemplated that the plurality of members may include a first set of substantially parallel spacer (e.g., wall) portions and a second set of substantially parallel spacer (e.g., wall) portions wherein the first and second portions are generally perpendicular with one another. The portions may extend from the surface of the substrate and optionally can include a gap located between the wall and surface of the substrate, which may be configured for allowing fluid flow of the plurality of masses therein.

In another configuration, the substrate includes an additional component for providing the members that define a plurality of openings. The additional component may be attached through attachment features including fasteners, snap fittings or otherwise. In one configuration, the additional feature comprises a mesh (e.g., wire or otherwise) forming a grid, matrix, array or a combination thereof. In one preferred configuration, the additional component includes portions similar to the integrally formed component for forming the openings. It is also typically preferable for the members of the additional component to form a grid.

The wall portions may extend continuously from the surface of the substrate and maintain separation of the pellets prior to and during melting. However, in one configuration, the wall portions may include one or more channels, through holes, or the like, for fluidly connecting the openings. This configuration allows the connecting of the material forming the pellets upon melting of the same.

The openings formed on the substrate may be provided randomly or in a pattern. In one preferred configuration, the openings are formed in an array to form a grid which extends along the length and width of the substrate. The openings may be formed of square shaped recesses, rounded recesses or otherwise. In another embodiment, the openings are provided in a pattern corresponding to a desired design.

The size of the openings formed in the substrate may vary depending on a desired resolution of the mosaic design to be formed, wherein the resolution is at least in part dependent upon the number of opening per unit area of measurement. For example, in a relatively low resolution configuration the substrate may include about 4 openings per square inch. While a higher resolution configuration may include 9 openings per square inch, or 16 or more openings per square inch. It should be appreciated that the total number of openings located on the substrate may be dependent upon the dimension of the substrate.

The substrate is preferably configured for withstanding elevated temperatures commonly found in a cooking oven. Accordingly, the substrate may be configured to withstand temperatures used to cause the melting of the pellets without substantial deformation of the same.

However, in one configuration, it is contemplated that at least a portion of the substrate (e.g., the portions or attachments) may be configured for deformation during the application of heat, as stated above. The deformation may comprise plastic deformation of the component or melting of all or a portion of the component. In one configuration, the portion of the substrate forming the openings (e.g. the walls or otherwise) are configured to melt at a temperature similar to the melting temperature of the pellets placed therein.

The substrate may comprise materials configured to withstand elevated temperatures used for causing melting of the pellets. The substrate may be rigid, or semi-rigid (e.g., see FIG. 4) or flexible (e.g., see FIG. 6). Suitable materials include metals, plastics, rubber, ceramic or otherwise. However, in one preferred configuration, the substrate comprises a stamped aluminum.

The members 22 forming the opening of the substrate may comprise the same material as the rest of the substrate or may comprise a different material. In one configuration, the material of the walls comprise a lower melting point than the rest of the substrate and more preferably includes a melting temperature similar to the melting temperature of the plurality of masses.

The substrate may be shaped in a geometric or non-geometric shape. For example, the substrate may include a shape comprising an oval, circle, square, rectangle, triangle, or otherwise. Alternatively, the substrate may include an irregular shape or have a corresponding shape to a theme of a design. For example, the shape of the substrate may comprise an outline of a character, building, environmental region such as a jungle or dessert or ocean or otherwise, planetary or other celestial bodies, or otherwise. Also, the substrate may comprise all or a portion of a frame for display of the completed mosaic design.

Also, the substrate may be opaque, transparent or a combination thereof. For example, the substrate may comprise an opaque member having one or more base colors. Optionally, the base colors may correspond to the theme as previously described. In one configuration, the substrate is at least partially transparent for allowing viewing therethrough. For example, the substrate may be at least partially transparent within the opening for allowing viewing of a map or the like for providing indications of placement of a specific type of pellets (e.g., color, hue, etc.).

Map

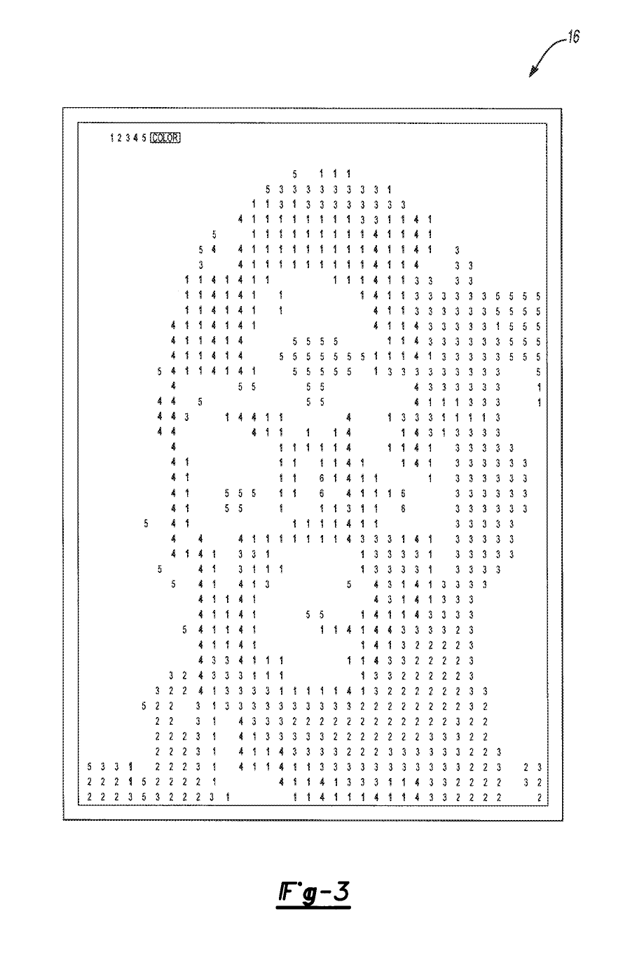

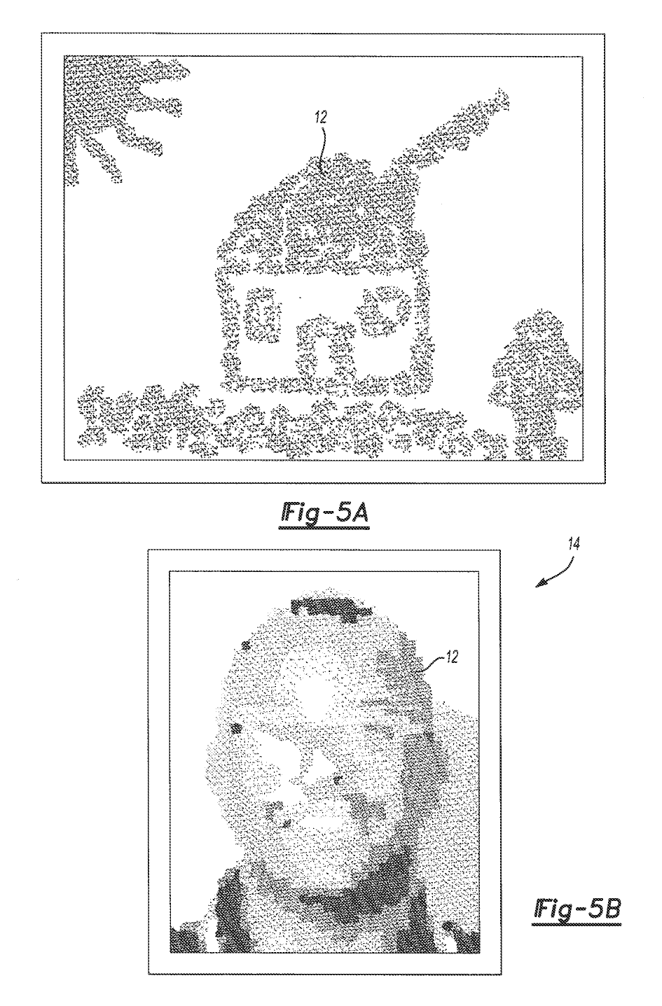

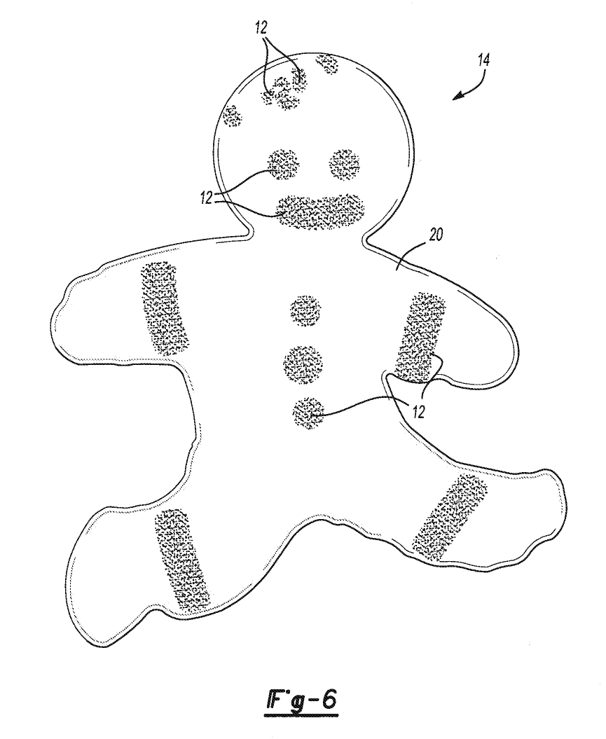

Referring to FIGS. 1 and 3, the system also typically includes a map 16 that is compatible with the substrate. In particular, the map typically includes markings and is adapted to be placed adjacent the substrate such that the markings of the map align with the openings of the substrate. Preferably, the map has a shape corresponding to the formation of openings on the substrate. The map may also include a shape corresponding to the shape of the substrate. Optionally, the map may include all or a portion of an attachment feature (e.g., a clip) for mounting to the substrate such that the map aligns with the openings formed on the substrate.

The markings of the map typically correspond to a graphical representation of a visually appealing object to a user. As such, the representation may comprise a drawing, painting, picture, sculpture, statue, scenic view, the like, or otherwise.

The markings typically indicate which type of pellet (e.g., color, hue or otherwise) is to be placed into which openings of the substrate. Accordingly, it is contemplated that the map includes at least one indication per opening for placement of one or more pellets. In one preferred embodiment, the map provides one indication per opening for placement of a certain type of pellet. However, the map may include numerous indications of pellets to be place into a single opening. For example, the map may provide for a sequential placement of a plurality of different or like pellets within an opening.

The markings may comprise numbers, letters, shapes, colors, combinations thereof or otherwise for providing indication for placement of a pellet. As such, the pellet may also include numbers, letters, shapes, colors, combinations thereof or otherwise corresponding to the markings. Accordingly, the marking provides indications or direction for placement of different color, hue, effects or otherwise of pellets for forming the design.

In view of the foregoing, the map may have a corresponding resolution to the substrate. Alternatively, it is contemplated that the map may also be configured with higher or lower resolution than a given substrate. For example, the map may contain a first side with a first resolution for a first substrate and a second side with a second resolution for a second substrate. Also, the map may be configured with a single side configured for different resolution, wherein the map may include multiple indications of placement of material per opening formed in a single substrate.

Generally, it is contemplated that the map may be removable from the substrate and/or pellets after assembly of the pellets to the substrate but prior to pellet melting. The map may remain with the substrate and/or pellets during melting of the pellets. The map may also be integral formed with the substrate such that the markings are on the substrate.

Program

The system may further include software for the creation of a map according to the desires of a user. The software may be configured to be installed and operated through a personal computer. Alternatively, all or a portion of the program may be located remotely, wherein the user provides the remote location with a graphical representation to be converted into a map. In either configuration, the software may be configured to convert a graphical representation into a map for use with the system.

In one configuration, the software is further configured to import graphical representations as described herein. Accordingly, the software may communicate with one or more drives or devices (e.g., cameras, scanners, video cameras, printers or otherwise) for obtaining information relating to the graphical representation. Also, the software may also provide the ability of the user to make a computer generated graphical representation (e.g., through AutoCad™, Catia™, Microsoft Paint™ Solid Works™, Mosaic Creator (provided at http://aolej.com/mosiac) or otherwise) to be converted or otherwise formed into a map.

The software is further configured to convert the graphical representation into a map which preferably provides optimal visual depiction of the completed mosaic design. Accordingly the software is configured to create a map based upon the overall image being represented. Not only does this relate to the color to be used for each opening but may also include adjustment of colors, shades, hues, effects or otherwise for providing an optimum image.

Optionally, the software may provide recommendations on colors to be used for the map. The software may be calibrated to make these suggestion based upon a specific model or type of system used. For example, the software may be adapted to formulate a map to represent a graphical image based upon the resolution of the substrate and colors provided in the model or kit. Accordingly, the software program is configured to provide a pellet grid corresponding to the openings formed in the substrate (i.e., a map that locates its marking in or adjacent openings into which pellets are to be placed accordingly to the markings).

As previously mentioned, all or a portion of the software may be located at a remote location, wherein the remote location creates a grid based upon the graphical information provided and other provided information. Communication with the remote location may be achieved via the mail service or over the internet. In one configuration, the remote location comprises an interactive website configured for receiving a graphical representation and converting the same into a map.

The website may further be configured for providing one or more of the components of the system of the present invention including maps, substrates, pellets, or otherwise. For example, the website may provide the ability to place an order for additional system components. Furthermore, the website may provide preformed maps having popular graphical representations (e.g., Statute of Liberty, Mt. Rushmore, scenic views, or otherwise). Also, the website may also provide a gallery of pictures for conversion into a map. Still further, the website may be configured for the sharing of graphical representations.

Kits

The present invention also contemplates providing the system of the present invention in a kit form. In one preferred configuration, the kit include a plurality of pellets comprising different shades of color, hue or otherwise. Preferably, the kit provides at least 6 different colors and/or hues, more preferably more than about 12 colors and/or hues and still more preferably more than about 24 colors and/or hues. As an example, the kit can include pellets having at least about 4 grayscales, more preferably at least about 7 grayscales and still more preferably at least about 10 grayscales. Optionally the kit may include pellets having other effects.

The kit also includes at least one substrate for placement of the pellets. The substrate may include a plurality of openings formed therein. However, in one preferred configuration, the kit includes one or more separate grids for forming the openings, which optionally comprises different resolution (e.g., different openings per square inch). It should be noted that the substrate may be such that the grid forming members may be removable from another portion of the substrate before or after formation of a mosaic design and may be removed along with the design or without.

Optionally, the kit may also include one or more maps for forming a design corresponding to the resolution of the carrier. The maps may be configured for drawing or sketching by a user to form the design or it may be configured for printing with the use of the software discussed herein or otherwise. Accordingly, the kit may further include software for the creation of a map including a design corresponding to a given substrate. Still further, one or more maps may be provided with preconfigured designs.

Method of Forming a Mosaic Design

In one method of forming a mosaic design, a user provides a substrate defining a plurality of openings. Optionally, the user attaches a map to the substrate for providing indication for placement of pellets within the openings formed in the substrate.

The user then places one or more pellets onto or over the substrate according to one or more markings provided by the map. The substrate and pellets are then placed within a heating device to cause the pellets to melt and optionally attach to the substrate. The substrate and pellets are then removed and allowed to cool leaving a mosaic design.

Optionally, the resulting mosaic design is attached to a frame, or alternatively the substrate comprises the frame, and is displayed.

In another method, referring to FIG. 6, the method provides a substrate having a preformed color and design. A user places one or more pellets onto the substrate to form a free-form design. The user then applies heat to the substrate and pellets causing the pellets to melt and attach to the substrate.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

What is claimed is:

1. A design system, comprising:
a plurality of masses of meltable material;
a map indicating where the masses are to be located wherein the map correlates to a design to be formed by the masses;
wherein, upon location of the masses according to the map, the masses can be melted to cooperatively form a representation of the design.

2. A system as in claim 1 wherein the masses are of multiple different colors or hues.

3. A system as in claim 1 further comprising a substrate with multiple openings configured for receiving the masses of material.

4. A system as in claim 3 wherein the map has markings corresponding to or aligning with the openings for indicating which masses are to be inserted into which openings.

5. A system as in claim 1 wherein the map is computer generated.

6. A system as in claim 1 wherein the representation is a mosaic of the design.

7. A system as in claim 1 wherein the design is a picture and a computer program has output the map based upon the picture.

8. A system as in claim 1 wherein the masses are formed of a thermoplastic polymeric material.

9. A system as in claim 1 wherein the masses are pellets that are substantially consistent in size and shape.

10. A system as in claim 1 wherein the multiple masses include 20 or more masses.

11. A system as in claim 1 wherein the multiple masses include a blowing agent.

12. A system as in claim 4 wherein the openings are in the form of a grid that is formed by the substrate.

13. A design system, comprising:
a plurality of masses of meltable material, wherein the masses are of multiple different colors or hues;
a substrate having multiples openings for receiving the masses of material;
a computer generated map having markings corresponding to or aligning with the openings for indicating which color or hue masses are to be inserted into which openings wherein the map correlates to a design; and
wherein, upon insertion of the masses into the multiple openings according to the map, the substrate and masses are exposed to heat from an oven for melting or making flowable the masses such that the masses cooperatively form a mosaic of the design.

14. A system as in claim 13 wherein the design is a picture and a computer program has output the map based upon the picture.

15. A system as in claim 13 wherein the masses are formed of a thermoplastic polymeric material.

16. A system as in claim 13 wherein the masses are pellets that are substantially consistent in size and shape.

17. A system as in claim 13 wherein the multiple masses include 20 or more masses.

18. A system as in claim 13 wherein the openings are in the form of a grid that is formed by the substrate.

19. A design system comprising:
a plurality of masses of meltable material, wherein the masses are of multiple different colors or hues and wherein the masses are formed of a thermoplastic polymeric material and wherein the masses are pellets that are substantially consistent in size and shape wherein the multiple masses include 20 or more masses;
a substrate having multiples openings for receiving the masses of material wherein the openings are in the form of a grid that is formed by the substrate;
a computer generated map having markings corresponding to or aligning with the openings for indicating which color or hue masses are to be inserted into which openings wherein the map correlates to an artistic design and wherein the design is a picture and a computer program has output the map based upon the picture; and
wherein, upon insertion of the masses into the multiple openings according to the map, the substrate and masses are exposed to heat from an oven for melting or making flowable the masses such that the masses cooperatively form a mosaic of the artistic design.

20. A system as in claim 19 wherein the multiple masses include a blowing agent.
